(19) United States
(12) Patent Application Publication
(10) Pub. No.: US 2017/0279743 A1
(43) Pub. Date: Sep. 28, 2017

(54) Subgroup Messaging

(71) Applicant: Cisco Technology, Inc., San Jose, CA (US)

(72) Inventors: Mingfeng Yang, Anhui Province (CN); Yasi Xi, Anhui Province (CN); Gergely Lukacsy, Galway (IE); Jun Wang, Anhui Province (CN); Harley Liang, Anhui Province (CN)

(21) Appl. No.: 15/079,274

(22) Filed: Mar. 24, 2016

(51) Int. Cl. H04L 12/58; H04L 29/06

(52) U.S. Cl. CPC H04L 51/04; H04L 65/403

(57) ABSTRACT

In one embodiment, instant messages or collaboration messages are organized in subgroups. A device is configured to receive data indicative of collaborative messages, identify a subgroup identifier from a first collaborative message of the collaborative messages, and encode the first collaborative message for transmission to a subgroup of receiving endpoint devices. The device identifies a second collaborative message and encodes the second collaborative message for transmission to a group of receiving endpoint devices including the subgroup of receiving endpoint devices. The first collaborative message is sent to or displayed by the subset of receiving endpoint devices and the second collaborative message is sent to or displayed by the receiving endpoint devices including the subgroup. The encoding is performed at the endpoint device or an associated server.

### TECHNICAL FIELD

This disclosure relates in general to the field of control and routing of collaboration messages, and more particularly to the initiation and control of subgroup messages in a collaboration system.

### BACKGROUND

Early instant messaging systems included real time text typed between command line utilities. Real time text means that individual characters are sent as the characters are typed and become visible one at a time. Only one user or endpoint is typically connected to only one other user or endpoint. Significant advances have been made, including graphical user interface based messaging clients.

Further advancements have led to open source standards and open source protocols standardized instant messaging under the descriptor Extensible Messaging and Presence Protocol (XMPP). XMPP servers may connect endpoints using a variety of clients.

As the primary function instant messaging transitions from primarily an entertainment focused “chat” session to a primarily business focused “collaboration” session, additional features are desired by users. For example, virtual rooms allow users to collaborate using other media than simple textual instant messages. Some virtual rooms may reach a high number of users such as hundreds of users. When a small number of users desire to discuss or collaborate on a smaller topic that does not involve the entire high number of users, a new chat room is created. This is inconvenient for users to join multiple chat rooms and mentally track multiple chat rooms.

### BRIEF DESCRIPTION OF THE DRAWINGS

Exemplary embodiments of the present embodiments are described herein with reference to the following drawings.

FIG. 1 illustrates an example collaboration group without subgroups.

FIG. 2 illustrates an example system for establishing and controlling subgroups in a collaboration session.

FIG. 3A illustrates an example collaboration session with subgroup messages inline with the collaboration session.

FIG. 3B illustrates another example collaboration session with subgroup messages inline with the collaboration session.

FIG. 4 illustrates an example subgroup configuration interface.

FIG. 5 illustrates another example subgroup configuration interface.

FIG. 6 illustrates a subgroup subscription interface.

FIG. 7 illustrates an example endpoint device.

FIG. 8 illustrates an example flowchart for the endpoint device of FIG. 7.

FIG. 9 illustrates an example network device.

FIG. 10 illustrates another example flowchart for the network device of FIG. 9.

### DESCRIPTION OF EXAMPLE EMBODIMENTS

### Overview

In an embodiment, a method includes receiving data indicative of a plurality of collaborative messages from an initiating endpoint device, identifying a subgroup identifier from a first collaborative message of the plurality of collaborative messages, encoding the first collaborative message for transmission to a subgroup of receiving endpoint devices, identifying a second collaborative message from the plurality of collaborative messages, encoding the second collaborative message for transmission to a plurality of receiving endpoint devices including the subgroup of receiving endpoint devices, and sending the first collaborative message to the subgroup of receiving endpoint devices and the second collaborative message to the plurality of receiving endpoint devices including the subgroup.

In another embodiment, an apparatus includes a processor and a memory comprising one or more instructions executable by the processor to perform identifying a subgroup identifier from a received collaborative message, wherein the subgroup identifier indicates a subgroup for messages as a subset of a main group for messages, querying a memory for the subgroup identifier, receiving an address for a receiving endpoint device from the memory, receiving a moderator for the subgroup identifier from the memory, and assigning moderator privileges to the moderator for the subgroup.

### EXAMPLE EMBODIMENTS

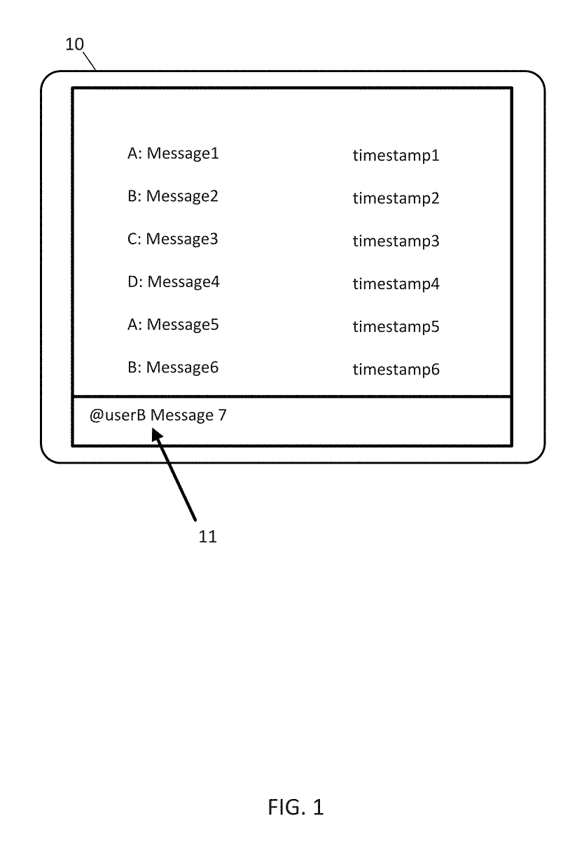

FIG. 1 illustrates an example of an interface 10 displaying a collaboration session with no subgroups. Some instant message and collaboration systems allow the transmission of private messages. For example, as shown by message 11, a designation such as “@userB” may direct a particular message to the user having the username of “userB.” However, there is only one recipient of the private message. Likewise, subsequent messages from user1 back to the original sender must also be designated with the “@” command.

The following embodiments include systems and techniques for creating subgroups with more functionality that private messages. The user may create a subgroup from a larger collaboration group or main group, but the subgroup operates independently from the larger collaboration group or main group. The term independently may mean that the subgroups have different members than the larger collaboration group (main group), are displayed differently than the larger collaboration group (main group), includes different features than the larger collaboration group and/or is administered by a different moderator. The user may add a prefix to a message with a subgroup name, and a subgroup is created automatically between the sender of the message and the recipient of the message. The subgroup messages of the subgroup may be displayed within the larger collaboration group to all of the members of the subgroup.

The subgroup may have a moderator independent of the larger collaboration group. That is, one user or endpoint may be an administrator or moderator of the larger collaboration group and another user or endpoint may be an administrator or moderator of the subgroup. This solves a technical problem that exists in large collaboration groups when different subgroups cannot be independently controlled. The independent control of the subgroup from the main group improves the efficiency of the communication of the messages because some messages need not be transmitted or displayed to some users.

In other words, the ease of computer networks in creating a large collaboration group of connected endpoint creates a problem that individual users may be inundated by a high volume of messages. The following embodiments allow for the creation of subgroups and independent control of the subgroups to alleviate this problem.

The subgroup may have properties and settings different from the larger collaboration group or main group. For example, different types of data may be attached to subgroup messages than the types of data that may be attached to messages in the main group. Data that may be attached to messages may include documents, photos, videos, contact cards, or other types of data. In some examples, data attachments are restructured in the larger collaboration group, which provides efficiencies in bandwidth because data attachments are sent to subgroup members only.

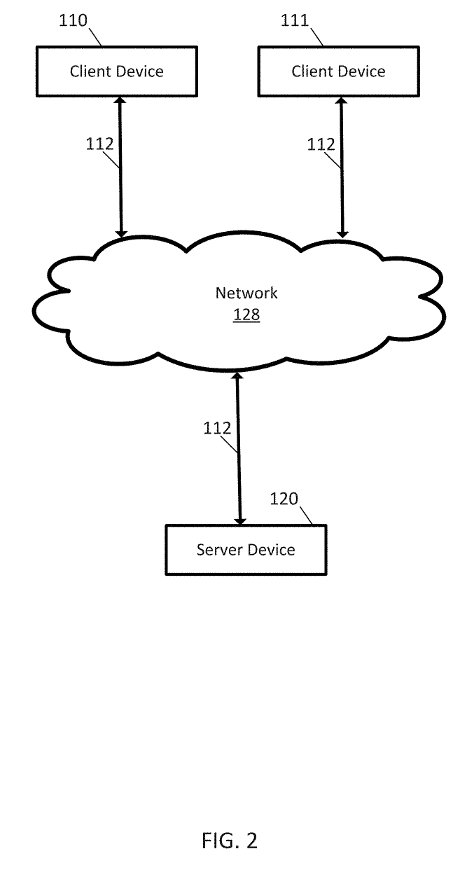

FIG. 2 illustrates an example system for establishing and controlling subgroups in a collaboration session. The system includes a client device 110, a client device 111, and a server device 120, which communicate via a network 128 and communication paths 112. The communication that may occur through the transport layer is part of an open system interconnection (OSI) model that defines a networking framework for implementing protocols in seven layers. Control in this model is passed from one layer to the next, starting at the seventh layer and proceeding to the first layer. The layers from the seventh to the first are application, presentation, session, transport, network, data-link, and physical. The fourth layer (L4) is the transport layer. The network 128 may include one or more transmission control protocol/internet protocol (TCP/IP) networks. Additional, different, or fewer components may be included.

The client device 110 and the client device 111 may be a smartphone, laptop, a tablet, a desktop computer, and/or another type of device. The client device 110 may be combined with or connected through another device such as a customer edge router, a gateway, a firewall or another network administrative device. The client device 110 may send one or more requests data via web browsers, email applications, instant messaging applications, and/or voice over internet protocol (VoIP) application. TLS may encrypt data associated with a layer four (L4) transport protocol for use in end-to-end connections across a network. The server device 120 may include a web hosting server, an email server, an instant messaging server, or a VoIP server. TLS may be used to protect web traffic, session initiation protocol, or simple mail transfer protocol. TLS may be used to establish a virtual private network may be used to tunnel traffic between the client device 110 and the server device 120.

Various encoding schemes may be used to define the collaboration subgroup. A subgroup message, as well as the main group message, may be packaged as a data packet of extensible markup language (XML). The messages may be XML stanzas. An XML stanza includes one or more data fields indicating XML data. In one example, the XML stanza is defined according to a predetermined element name included in the text of the XML stanza. Examples for the predetermined element name include message, presence, or info-query. Other messages, control messages, i.e., not XML stanzas, may include error message, configuration messages, or system messages. The XML stanza may include one or more control elements related to attributes of the XML stanza. Attributes may include a version number for the XML stanza or the instant messaging program or service. Attributes may describe an address or other identifying data for a server of the instant messaging service. The XML stanza may include character data that defines the text of the message. The subgroup messages may include one or more hierarchical data fields identifying a hierarchy including a main group and at least one subgroup. The XML stanza may have a predetermined byte size or a maximum byte size.

XML stanzas named message may include the message text or other characters. The message stanzas may be configured for a push mechanism from one device to another. XML stanzas named presence may include data indicative of network status or device status. Example presence statuses for a device or endpoint may include available, online, and busy. The presence stanza may be configured for a publish and subscribe mechanism. That is, any device may subscribe to the presence stanzas of another device. Accordingly, the presence data is advertised to others. XML stanzas named info-query (IQ) may include a structured exchange of control data between endpoints. The IQ stanzas may be configured for a request response mechanism. That is, one device or endpoint sends a request to another endpoint, and the other endpoint responds with a reply.

The client device 110 and the server device 120 may establish the XMPP session over the network 128 according to the following procedure. First, a fully qualified domain name is established. For example, the client device 110 may identify a domain name or IP address associated with the client device 111. The client device may be listed in a contact list that associates usernames with domain names or IP addresses. The domain name is a fully qualified domain name as confirmed by a domain name system server. The client device 110 may send a query to the domain name system server including an XMPP identifier and a domain name for the service. The XMPP identifier may be an indication the query is part of an XMPP session. The domain name for the service may identify the domain name of the server device 120. The domain name server may respond with an IPv4 or IPv6 address and/or a port number for the server device 120. In one example, multiple IP addresses are returned.

Second, the client device 110 may initiate a transport control protocol (TCP) connection using the IP address received from the domain name system. When multiple IP addresses are received from the domain system, the IP addresses may be used in order until a TCP connection is successfully established. The order may be the order in the return query or another order determined by the client device 110.

Third, the client device 110 establishes an XML stream over the TCP connection. The XML stream is established through sending a first stream header to the server device 120 including the IP address received from the FQDN lookup. The first stream header includes at least the address of the client device 110 and the server 120 and one or more XMPP settings for the XML stream. The server device 120 responses with a second stream header also including at least the address of the client device 110 and the server 120 and at least one setting that may be modified from the settings of the first stream header.

Other security mechanism may be included. For example, the client device 110 may initiate transport layer security (TLS) and/or simple authentication and security layer (SASL). In TLS, the client device 110 and the server device 120 may complete a TLS handshake and establish cryptographic parameters for a channel to communicate the XML stanzas. The server device 120 may be authenticated to the client device 110 through TLS and vice versa. In addition, the server device 120 may be authenticated to the client device 110 through SASL and vice versa. In SASL, authentication may be performed for the XML Stream using an XMPP profile.

Fourth, the client device 110 and the server device 120 generates one or more XML stanzas including one or more attributes and one or more elements. A version element may describe a version of the instant messaging client or a version of XMPP. The server device 120 may generate an element including conditions for the XML stream. The server device 120 may generate a features element. The features element may be a mandatory feature that the client device 110 confirms in order for the XML stream to continue. The features element may be a voluntary feature that the client device 110 may either confirm or not and still continue with the XML stream.

A features element may identify a subgroup message service. In one example, a flag to indicate a features element (e.g., <features>) and a flag to indicate subgroup messages (e.g., <subgroup>) are included in a packet (e.g., XML stanza).

The client device 110, which may be referred to as an initiating endpoint device, generates one or more packets or collaborative messages including the features element that indicates whether the packet belongs to a subgroup message or a main group message. The client device 110 sends data for at least one of the collaborative messages to the server device 120. The server device 120 receives the collaborative messages and identifies whether each message is a subgroup message or a main group message. In one example, the server device 120 reads the features element that includes either a subgroup identifier or a main group identifier. In one alternative, the absence of the subgroup identifier indicates that the message belongs to the main group or the absence of the main group identifier indicates that the message belongs to a subgroup.

When the subgroup identifier is present, the server device 120 encodes the collaborative message for transmission to a subgroup of receiving endpoint devices. The subgroup of receiving endpoint devices may include the client device 111. When the main group identifier is present, the server device 120 encodes the collaborative message for transmission to multiple receiving endpoint devices including the client device 111. In either case, the server device 120 sends the collaborative message to the designated endpoint or endpoints.

Subsequent messages may be exchanged between the client device 110 and the client device 111 through the server device 120 and the subgroup designations. Finally, the client device 110 closes the XML stream and closes the TCP connection. The client device 110 may generate and send an XML message including a close stream tag in order to close the XML stream. The client device 110 may close the TCP connection.

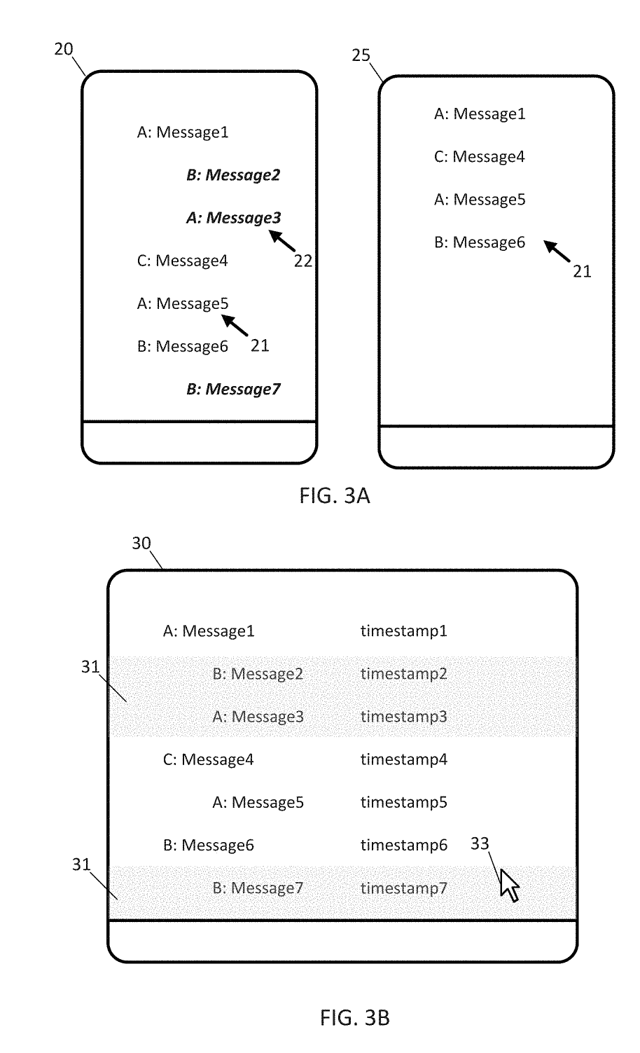

FIG. 3A illustrates an example interface 20 for a collaboration session with subgroup messages inline with the collaboration session. The term inline may be defined such that the subgroup messages are arranged in order with the other public or main group messages of the collaboration session. In the example illustrated by FIG. 3A, the collaboration session includes messages 1-7. The main group messages 21 include messages 1 and messages 4-6. The subgroup messages 22 include message 2, message 3, and message 7. For users or endpoints that are members of the subgroup, both the main group messages 21 and the subgroup messages 22 are displayed, as shown in FIG. 3A. For users or endpoints that are not members of the subgroup (e.g., members of another subgroup or not members of any subgroup), only the main group messages 21 are displayed.

The subgroup messages 22 may be graphically indicated as part of a subgroup. The text of the subgroup may be altered. The text of the subgroup messages 22 may be bolded, italicized, or colored differently than the text of the main group messages 21. The subgroup messages 22 may be bolded and the main group messages 21 are not bolded, or vice versa. The subgroup messages 22 may be italicized and the main group messages 21 are not italicized, or vice versa. The subgroup messages 22 may be colored a first color and the main group messages 21 may be colored a second color.

The subgroup messages 22 may be indented or justified differently than the main group messages 21. In one example, the subgroup messages 22 are indented by a predetermined distance from the main group messages 21. In one example, the subgroup messages 22 are right justified and the main group messages 21 are left justified. Other justification examples are possible. In another example, each subgroup message includes a textual identifier such as “[subgroup1]” preceding or otherwise is association with the message text.

The example interface 20 may include more than one set of subgroup messages 22. For example, the user or endpoint may be a member of multiple subgroups. The different subgroups may be distinguished using any of the techniques that distinguish the main group messages 21 from the subgroup messages 22. For example, one subgroup may be italicized, bolded, or colored differently than another subgroup. In one example, one subgroup may be indented or justified differently than another subgroup.

The example interface 20 may include a toggle switch for activating and deactivating the graphical indication of the subgroup messages. When the toggle switch is activated the subgroup messages 22 are displayed, which may include the graphical indicators, and then the toggle switch is deactivated the subgroup messages 22 are not displayed. The toggle switch may include a physical button or a switch on the graphical user interface. The switch may include a radial button, a slider bar, or a checkbox. A style switch may also allow the style of the graphical indicator (e.g., italics, bold, justification, indentation or another indicator) to be adjusted.

A subgroup message may be created from a main group message. For example, user A may post message 1. Message 1, which may be referred to as an earlier group message, may be sent from the client device 110 to the server device 120, and ultimately to client device 111. User B determines that a reply should be sent to message 1 but the reply should be limited to a subset of users. The user may select message 1 to create a subgroup including message 1 and the reply to message 1, message 2.

The selection of the earlier group message or message 1 may be made my clicking on message 1, and the subgroup may be created by a subgroup command, which may include selecting create subgroup from a menu of one or more items that appears in response to selecting message 1.

Alternatively, the subgroup command may be created from holding down a specified key (e.g., ctrl) and simultaneously clicking on message 1. In response to receiving a subgroup command, the server device 120 may generate a subgroup identifier. The subgroup message is a reply to the earlier group message. In response to the subgroup command (e.g., specified key and simultaneous click), the client device 110 may move a cursor to the input field, in which the user can enter text to be included in the subgroup messages. In response to the subgroup command, the client device 110 may prompt the user to “Enter a response to this message.”

In one example, the subgroup command may be generated in response to an alphanumeric instruction from a user. For example, the user may enter a tag such as “/subgroup1” before a message intended for subgroup1. The server device 120 may identify the tag and generate the subgroup message in response to the tag. The tag may include the subgroup identifier. In this way, the subgroup tag and the message text may be entered in a single line of text (e.g., /subgroup1 example message text).

The subgroup may include a default set of users or client devices. The default set may include the user or device that created message 1 and the user or device that created message 2. The user or device that created message 2 may be given default moderator privileges. The subgroup identifier may be indexed by the server device 120 according to moderator.

The subgroup identifier may be based, at least in part, on the identity of the client device that initiated the subgroup. The subgroup identifier may include at least a portion of the IP address for the initiating device. The subgroup identifier may include at least a portion of the MAC address for the initiating device. The subgroup identifier may include a username associated with the initiating device. The subgroup identifier may include a main group identifier. An alphanumeric value may be concatenated with the main group identifier. The subgroup identifier may include a data based on the timestamp associated with message 2. In one example, the subgroup identifier or a designation that the message or packet includes a subgroup identifier is indicated by a flag in a subgroup element within the XML stanza.

FIG. 3B illustrates an example of the subgroup messages and main group messages ordered in line according to a timestamp. The order may be chronological order such that messages that are earlier in time are displayed above messages are later in time. The timestamp may indicate a time that the messages were received. The timestamp may be assigned according to the local clock of the receiving device. The timestamp may indicate a time that the messages were send. In this case, the timestamp may be assigned according to the sending device. In this way, a message with a later timestamp may be received before a messages with an earlier timestamp.

For members of the subgroup, the subgroup messages and main messages are visible together in chronological order. For nonmembers of the subgroup, only the main group messages are visible, which may be in chronological order. Past subgroup members that have been removed from the subgroup also may only view the main group messages. In other words, to endpoint devices or users that are not currently members of the subgroup, the subgroup messages are invisible.

FIG. 3B also illustrates another example of a graphical indicator for distinguishing the subgroup messages from the main group messages. Highlighted or shading may be applied to a subgroup message area 31. The highlighting or shading is different than the background applied to the main group messages.

FIG. 3B may also illustrate a technique for identifying associations between subgroup messages. For example, a user may hover cursor or selection tool 33 to one of the subgroup messages. The client device 110 may identify a subgroup identifier for the selected subgroup message, and in response, identify one or more other messages that belong to the same subgroup. The client device 110 may highlight or otherwise graphically indicate the subgroup messages that belong to the same subgroup. In this way, a user may select a subgroup message including an answer (e.g., yes) to identify the earlier message that the answer refers to. Therefore, main group messages and one or more subgroup messages may be distinguished by the user with the messages remaining in line in a single window. In one alternative, rather than or in addition to highlighting, messages with the same subgroup identifier may be indicated with an arrow.

The subgroup may be assigned to a moderator. In one example, moderator privileges may be assigned to the endpoint device that initiated the subgroup message. In other words, an endpoint in the main group has submitted a main group message to a main group of messages, and the initiating endpoint device initiates the subgroup message in response to the main group message. The initiating endpoint device may be automatically assigned moderator privilege for the subgroup. The server device 120 may assign the moderator privilege is response to the subgroup message being created or in response to identification of the subgroup identifier. Moderator privilege may include rights to modify the subgroup. For example, the moderator may add or invite users or endpoints to the subgroup. The moderator may remove users or endpoints to the subgroup. The moderator may delete the subgroup.

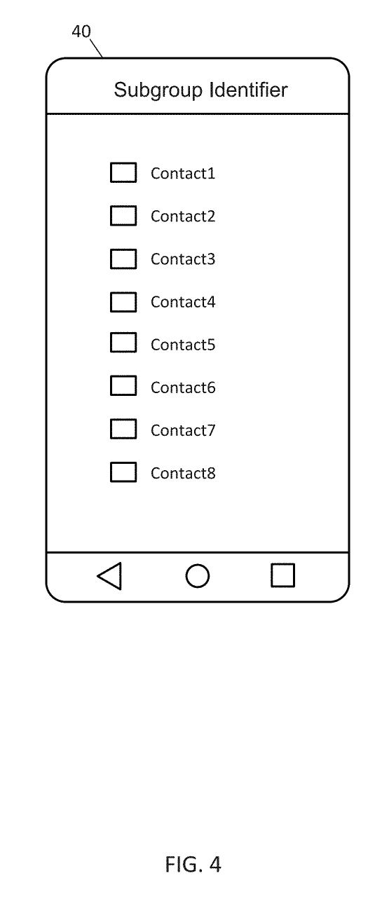

FIG. 4 illustrates an example subgroup configuration interface 40. The subgroup configuration interface 40 may receive one or more commands for changing the parameters of the subgroup. The parameters of the subgroup may include the members of the subgroup, the graphical indicators for displaying the subgroup, the title of the subgroup, or the description of the subgroup.

In one example, the moderator endpoint of the subgroup may edit or adjust any of the subgroup parameters. FIG. 4 illustrates that the subgroup configuration interface 40 may include a list of contacts for adding members to the subgroup. The list of contacts may be the members or participants of the main group. In one option, the list of contacts may be reduced to include only the contacts of the endpoint device. The list of contacts may be a list of users on the same network or domain as the endpoint device. Contacts may be checked or selected to add members to the subgroup. A similar technique may be applied to remove users or contacts from the subgroup.

In one example, the server device 120 may receive an invite command from the moderator (e.g., initiating endpoint). The invite command may include data indicative of a user of the subgroup to invite the user to the subgroup. In another example, the server device 120 may receive a removal command from the moderator. The removal command may include data indicative to remove a user from the subgroup.

The moderator may have access to assign a moderator privilege to another user or another endpoint. The server device 120 may receive a subgroup command for assigning a moderator privilege to an endpoint that is not currently the endpoint. The server device 120 assigns the moderator privilege to the other endpoint. In one example, the server device 120 may receive a removal command from the other endpoint that received moderator privileges from the initiating endpoint. The removal command includes data indicative to remove any member of the subgroup, including the other endpoint that has received moderator privileges from the initiating endpoint.

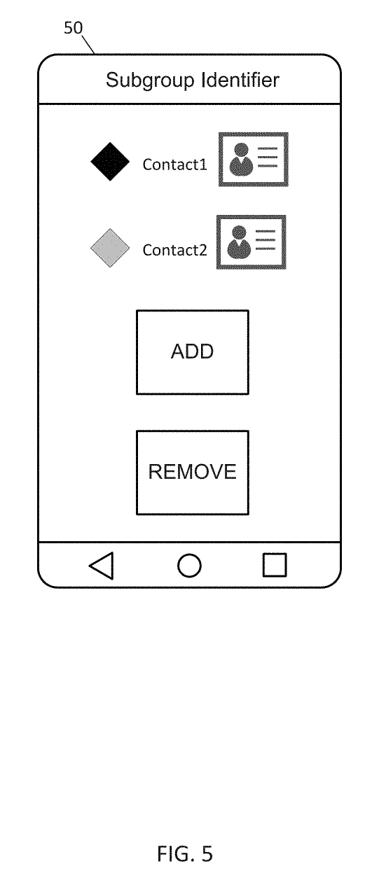

FIG. 5 illustrates another example subgroup configuration interface 50. For example, after one or more contacts are selected, interface 50 may be displayed to confirm the selection and receive instruction on whether the selected users or contacts should be added or removed. The interface 50 may receive the selection of contact1 and/or contact2 and an add button to add users to the subgroup, and the interface 50 may receive the selection of contact1 and/or contact2 and a remove button to remove users from the subgroup.

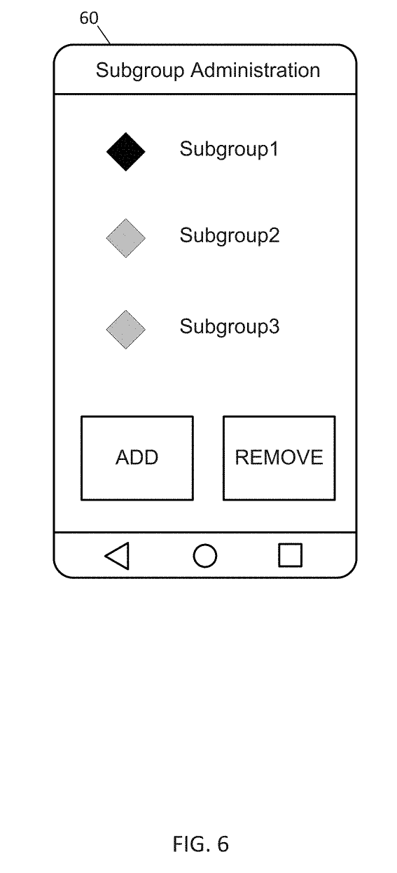

FIG. 6 illustrates a subgroup subscription interface 60. The subgroup subscription interface 60 allows the user to determine which subgroups are displayed. In addition or in the alternative, the subgroup subscription interface 60 allows the user to remove itself from the subgroup. Thus, the user may remove itself from the subgroup without revealing the removal to the reset of the subgroup. The subgroup subscription interface 60 may allow the user to select one or more subgroups that are available. The subgroup subscription interface 60 determines whether or not subgroup messages are displayed or whether or not the subgroup messages are received.

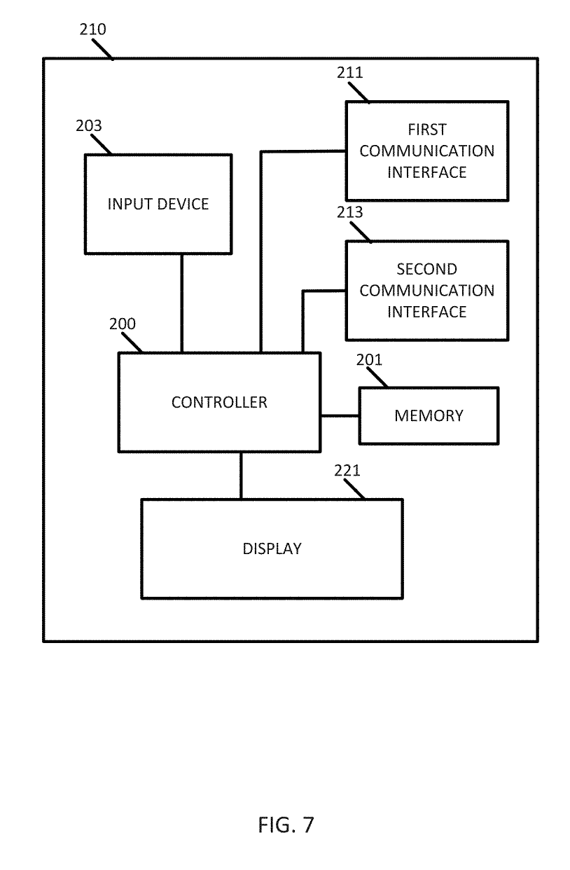

FIG. 7 illustrates an example computing device 210. The computing device 210 includes a controller 200, a memory 201, an input device 203, a first communication interface 211, a second communication interface 213, and a display 221. Additional, different, or fewer components may be provided. Different network devices may have the same or different arrangement of components.

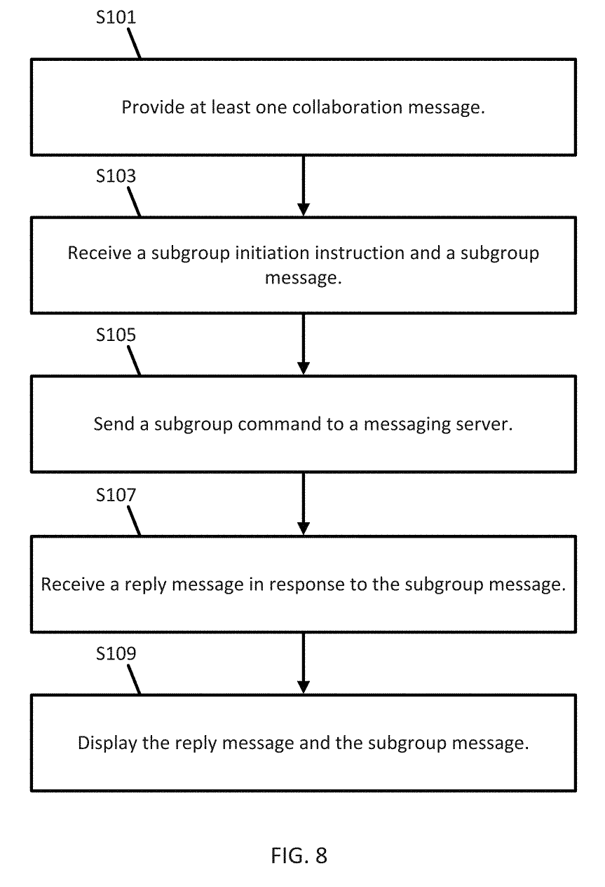

FIG. 8 illustrates an example flowchart for the computing device 210 of FIG. 7 such as the operation of the client device 110. Additional, different, or fewer acts may be included.

At act S101, the controller 200 is configured to provide at least one collaboration message to a user or to the display 211. The collaboration message may be received by another endpoint. The collaboration message may be an instant message sent by another user intended for a group of users including a user of the computer device 122.

At act S103, the controller 200 receives a subgroup initiation instruction and a subgroup message. The subgroup initiation instruction may be an instruction made by the user in response to the collaboration message from S101. The instruction may be received through the input device 203. The instruction may be a selection of the collaboration message in S101. The instruction may create a subgroup in reply to the collaboration message in S101.

In response to the subgroup initiation instruction, the controller 200 may prompt the user to enter the subgroup message. The subgroup message may include text and optionally, additional attachments. The controller 200 may assign a subgroup identifier to the subgroup message based on the subgroup initiation instruction. The subgroup identifier may identify one or more of the topic for the subgroup, the initiating device of the subgroup, or the member devices.

The controller 200 is configured to attach data to a reply to the collaboration message in S101. In one example, the controller 200 is configured to generate the subgroup and/or the subgroup identifier in response to the data attachment. In other words, any message that includes a data attachment is automatically added to a new subgroup if it does not already belong to a subgroup.

At S105, the second communication interface 213 may send the subgroup command to a messaging server (e.g., server device 120). All messages including main group massages and subgroup messages may be sent to the same messaging server. On one example, the messaging server identifies those messages that include subgroup identifiers and routes the messages accordingly. In another example, all messages are subscribed to by all endpoints and the individual endpoints determine which messages should be displayed or not displayed.

At S107, the controller 200 or the first communication interface 211 may receive a reply message in response to the subgroup message. The controller 200 may determine whether the reply message includes a subgroup identifier. When the reply message includes a subgroup identifier that corresponds to the sent subgroup message, at S109, the controller 200 causes the reply message to be displayed in association with the subgroup message. The controller 200 is configured to list the received collaboration message and the second collaboration message including the subgroup in chronological order based on a first timestamp for the received collaboration message and a second timestamp for the second collaboration message.

Sometimes a subgroup identifier in the reply message may not match the most recent subgroup message. In this case, the reply message and the subgroup message may be displayed with different graphical indicators. Example graphical indicators include color, bold, italics, justification, or other indicators. Sometimes there is no subgroup identifier in the reply message, and the controller 200 causes the reply message to be displayed as a main group message. Again, the main group message may be distinguished graphically from the subgroup messages color, bold, italics, justification, or other indicators.

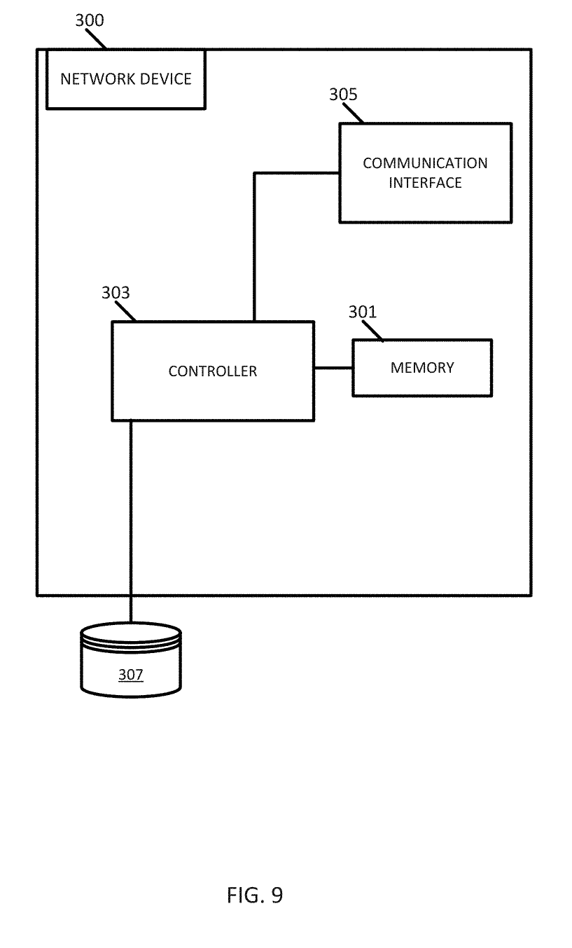

FIG. 9 illustrates an example network device 300, which may correspond to server device 120. The network device 300 includes at least a memory 301, a controller 303, and a communication interface 305. Additional, different, or fewer components may be provided. Different network devices may have the same or different arrangement of components.

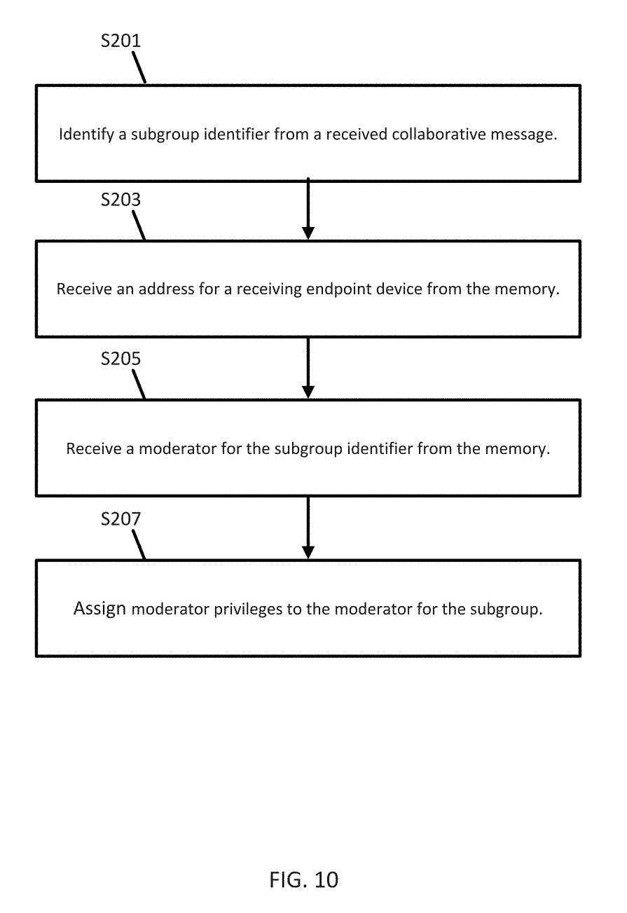

FIG. 10 illustrates another example flowchart for the network device of FIG. 9 such as the operation of the server device 120. Additional, different, or fewer acts may be included.

At act S201, the controller 303 identifies a subgroup identifier from a received collaborative message. The subgroup identifier indicates a subgroup for messages as a subset of a main group for messages. The subgroup identifier may include one or more codes that reference the members of the subgroup or the source of the message.

The subgroup message may have been initiated from an earlier message forwarded by the controller 303. Specifically, the earlier message may be selected to create the subgroup directly from the earlier message. The controller 303 is configured to encode the subgroup message for transmission a subgroup of receiving endpoint devices. The communication interface 305 is configured to send the received collaborative message to the subset of receiving endpoint devices. Other messages may be sent to the all receiving endpoint devices including the subgroup.

At act S203, the controller 303 queries the memory 301 using one or more codes from the subgroup identifier. The memory 301 may include a lookup table that associates the subgroup identifier codes with groups of endpoints, contracts, or addresses for the members of the subgroup. The memory 301 may include a lookup table that associates the subgroup identifier codes with topics or subject matter for the subgroup. The subject may reference a project, meeting, or purpose of the subgroup. The memory 301 may include a lookup table that associates the subgroup identifier codes with one or more policies for the subgroup. The policies may describe the types of data that may be exchanged, a maximum number or minimum number for permitted quantities of the members of the subgroup. The policies may describe the moderators and the access levels gives to users, or specific group of users. The access level may include presenter that indicates the user may provide messages or other data to the subgroup as well as view that of others. The access level may include viewer that indicates that the user may only view the messages or other data of others and not present to the subgroup.

In the example shown in FIG. 10, at act S205, the controller 303 receives an address for a receiving endpoint device from the memory 301, and at act S207, the controller 303 receives data indicative of a moderator for the subgroup identifier from the memory 301. The moderator may be a specific username, endpoint device, or address (e.g., IP address) that has moderator privileges.

At act S209, the controller 303 assigns moderator privileges to the moderator for the subgroup. The moderator privileges may include the ability to invite and/or remove users from the subgroup. The moderator privileges may include the ability to set the display features for the subgroup. The display features may determine whether or not the subgroup messages are displayed in line with the main group messages. The display features may determine what color, justification, or style is used to display the subgroup messages.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The controller 200 and/or the controller 303 may include a general processor, digital signal processor, an application specific integrated circuit (ASIC), field programmable gate array (FPGA), analog circuit, digital circuit, combinations thereof, or other now known or later developed processor. The controller 303 may be a single device or combinations of devices, such as associated with a network, distributed processing, or cloud computing.

The memory 201 and/or the memory 301 may be a volatile memory or a non-volatile memory. The memory 203 or 301 may include one or more of a read only memory (ROM), random access memory (RAM), a flash memory, an electronic erasable program read only memory (EEPROM), or other type of memory. The memory 301 may be removable from the network device 103, such as a secure digital (SD) memory card.

In addition to ingress ports and egress ports, the communication interface may include any operable connection. An operable connection may be one in which signals, physical communications, and/or logical communications may be sent and/or received. An operable connection may include a physical interface, an electrical interface, and/or a data interface.

The computing device 210 may include only the first communication interface 211 or both the first communication interface 211 and the second communication interface 213. In one example, the first communication interface 211 may coordinate incoming communication and the second communication interface 213 may coordinate outgoing communication. Different interfaces for any combination of the first communication interface 211, the second communication interface 213, and the communication interface 305 of the network device 200 may be assigned to wireless (the IEEE 802.11 family of protocols), cellular communications, voice of internet protocol (VoIP), email, instant messaging, session initiation protocol (SIP), extensible messaging and presence protocol (XMPP), microblog submissions (Twitter or status messages), other forms of communication.

The input device 203 may be one or more buttons, keypad, keyboard, mouse, stylist pen, trackball, rocker switch, touch pad, voice recognition circuit, or other device or component for inputting data. The input device 203 and the display 221 may be combined as a touch screen, which may be capacitive or resistive. The display 221 may be a liquid crystal display (LCD) panel, light emitting diode (LED) screen, thin film transistor screen, or another type of display. The display 221 is configured to display the first and second portions of the content.

The memory 201 and 301 are non-transitory computer-readable media, which may be a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
receiving data indicative of a plurality of collaborative messages from an initiating endpoint device;
identifying a subgroup identifier from a first collaborative message of the plurality of collaborative messages;
encoding, using a processor, the first collaborative message for transmission to a subgroup of receiving endpoint devices;
identifying a second collaborative message from the plurality of collaborative messages;
encoding, using the processor, the second collaborative message for transmission to a plurality of receiving endpoint devices including the subgroup of receiving endpoint devices; and
sending the first collaborative message to the subgroup of receiving endpoint devices and the second collaborative message to the plurality of receiving endpoint devices including the subgroup.

2. The method of claim 1, further comprising:
sending an earlier group message to the initiating endpoint device from one of the subgroup of receiving endpoint devices,
wherein the subgroup identifier is generated from the earlier group message and the subgroup of receiving endpoint devices is defined based on the initiating endpoint device and the one of the subset of receiving endpoint devices.

3. The method of claim 2, wherein the first collaborative message is a reply directed to the subgroup and in reply to the earlier group message.

4. The method of claim 1, further comprising:
assigning a moderator privilege to the initiating endpoint device in response to the subgroup identifier.

5. The method of claim 4, further comprising:
receiving an invite command from the initiating endpoint, wherein the invite command includes data indicative of a user of the subgroup to invite the user to the subgroup.

6. The method of claim 4, further comprising:
receiving a removal command from the first endpoint, wherein the removal command includes data indicative to remove a user from the subgroup.

7. The method of claim 1, further comprising:
assigning a moderator privilege to another user in the subgroup in response to the subgroup command from the initiating endpoint.

8. The method of claim 1, further comprising:
receiving a removal command from another user in the subgroup, wherein the removal command includes data to remove the other user from the subgroup.

9. The method of claim 1, further comprising:
listing the collaboration messages including the subgroup in chronological order.

10. The method of claim 1, wherein the subgroup identifier is generated from a selection on the earlier group message at the initiating endpoint device.

11. The method of claim 1, wherein the subgroup identifier is received as a flag in a subgroup element within the first collaborative message.

12. The method of claim 1, further comprising:
generating a graphical indicator for the first collaboration message in response to the subgroup identifier.

13. An apparatus comprising:
a processor; and
a memory comprising one or more instructions executable by the processor to perform:
identifying a subgroup identifier from a received collaborative message, wherein the subgroup identifier indicates a subgroup for messages as a subset of a main group for messages;
querying a memory for the subgroup identifier;
receiving an address for a receiving endpoint device from the memory;
receiving a moderator for the subgroup identifier from the memory; and
assigning moderator privileges to the moderator for the subgroup.

14. The apparatus of claim 13, wherein the processor is configured to perform:
encoding a second collaborative message for transmission to a plurality of receiving endpoint devices including the subgroup; and
sending the received collaborative message to the subset of receiving endpoint devices and the second collaborative message to the plurality of receiving endpoint devices including the subgroup.

15. The apparatus of claim 14, wherein the processor is configured to perform:
listing the received collaboration message and the second collaboration message including the subgroup in chronological order based on a first timestamp for the received collaboration message and a second timestamp for the second collaboration message.

16. The apparatus of claim 13, wherein the processor is configured to perform:
sending an earlier group message from an initiating endpoint device of the subgroup,
wherein the subgroup identifier is generated based on the initiating endpoint device and receiving endpoint device.

17. The apparatus of claim 16, wherein the received collaborative message is a reply directed to the subgroup and in reply to the earlier group message.

18. The apparatus of claim 16, wherein the subgroup identifier is generated from a selection on the earlier group message at the initiating endpoint device.

19. The apparatus of claim 13, wherein the subgroup identifier is received as a flag in a subgroup element within the first collaborative message.

20. A non-transitory computer readable medium including instructions configured to perform:
identifying a subgroup identifier from a first message;
encoding, using a processor, the first message for presentation at a subgroup of receiving endpoint devices;
identifying a second message; and
encoding, using the processor, the second message for presentation at a plurality of receiving endpoint devices including the subgroup of receiving endpoint devices,
wherein the first message and the second message are presented with different graphical indicators at the subset of receiving endpoint devices.
